(19) United States
(12) Patent Application Publication
(10) Pub. No.: US 2025/0216000 A1
(43) Pub. Date: Jul. 3, 2025

(54) DISPENSING DEVICE FOR WATER-DISPENSING UNITS

(71) Applicant: Fabrizio NOBILI, San Vittore (CH)

(72) Inventor: Fabrizio NOBILI, San Vittore (CH)

(21) Appl. No.: 18/843,901

(22) PCT Filed: Aug. 29, 2023
(86) PCT No.: PCT/IB2023/058514

§ 371 Date: Sep. 4, 2024

(30) Foreign Application Priority Data
Aug. 30, 2022 (IT) 102022000017823

(51) Int. Cl. F16K 31/60; F16K 11/074; F16K 31/56

(52) U.S. Cl. CPC F16K 31/605; F16K 11/0743; F16K 31/56

(57) ABSTRACT

An adjusting device for water-dispensing units is disclosed comprising: a valve body with a first inlet for the cold water, a second inlet for the hot water and an outlet for the mixed water, shutter means for controlling a flow of water, a mixing chamber for mixing the water to a desired temperature, first actuating means for arranging the shutter means in an open position, in a closed position to enable/disable the transit of the water, and in an intermediate adjustable position for adjusting a flow of water, second actuating means configured to adjust a water temperature, a first control member in a single piece connected to the first actuating means and configured to open, close dispensing and to adjust the flow rate of the water manually, a second control member connected to the second actuating means to vary the water temperature manually.

### BACKGROUND OF THE INVENTION

The invention relates to an adjusting device for water-dispensing units, in particular a device that is drivable manually to open, close and adjust the flow rate and temperature of water in dispensing units intended to be installed in showers, kitchen sinks or washbasins etc.

Specifically but not exclusively, the adjusting device according to the invention can be installed in a water-dispensing unit of the recessed type.

### PRIOR ART

Adjusting devices are known for water-dispensing units in a shower or sink or washbasin, which are for example installed in a shower panel or on a surface of the sink or washbasin.

For example, patent EP2865928B1 describes a system for opening and closing a domestic water dispenser. This prior art dispenser comprises a pushbutton that is actuatable by an operator to open or close water dispensing. The pushbutton is further rotatable to enable the flow rate being dispensed to be adjusted.

Further dispensing devices are also known that in addition to closing and opening, dispensing and adjusting the outgoing flow rate, also adjust the temperature of the dispensed flow.

Nevertheless, such dispensing devices are structurally complex and not satisfactorily convenient and versatile in use. The particular rather complicated and bulky structural conformation also detracts from the visual appeal to the user. In particular, these adjusting devices, through the structural configuration thereof, protrude significantly with respect to a plane (shower panel or washbasin surface) on which the water-adjusting units are fitted.

In the light of the above, there is thus much room for improvement of current water-dispensing devices.

### OBJECTS OF THE INVENTION

One object of the invention is to improve current devices for adjusting water.

Another object of the invention is to provide an adjusting device configured as to improve driving of the shutter means; in particular, the invention aims to provide a solution that enables a user to perform the tasks of opening, closing and adjusting the flow rate and temperature of the flow of water and that is simultaneously structurally simplified and at the same time has enhanced performance and operating versatility.

A further object of the invention is to provide a solution that makes it possible to constructionally simplify the adjusting device and at the same time improves operating versatility.

A still further object is to provide a solution that reduces the overall dimensions of the device and the space required to install the device on a shower panel or other similar wall of a dispensing unit, also making it possible to obtain advantages also from the aesthetic point of view.

### SUMMARY OF THE INVENTION

Such objects and still others are achieved by a system as defined in the attached claims.

Owing to the adjusting device according to the invention, it is possible to both enable/disable water dispensing and adjust the flow rate and temperature of the water dispensed conveniently by just two control members.

Owing to the arrangement of the control members of the adjusting device, in particular in a water dispensing closed position, it is possible to have at one's disposal a compact adjusting device with relatively limited overall dimensions.

Owing to the configuration of the control members, it is possible to make available to the user a peripheral driving zone only when water dispensing is enabled.

### SHORT DESCRIPTION OF THE DRAWINGS

The invention can be better understood and implemented with reference to the attached drawings that illustrate embodiments thereof by way of non-limiting example, in which:

FIG. 1 is a perspective view of an adjusting device according to a first embodiment in a closed position of shutter means;

FIG. 2 is a perspective view of the adjusting device of FIG. 1 in a totally open position of the shutter means;

FIG. 3 is a raised section of the adjusting device according to a plane passing through a longitudinal axis of the adjusting device, in which the adjusting device is in the closed position;

FIG. 4 is a raised section of the adjusting device according to a plane that is orthogonal to the section plane of FIG. 3, in which the adjusting device is in the closed position;

FIG. 5 is a raised section of the adjusting device according to a plane passing through a longitudinal axis of the adjusting device, in which the adjusting device is in an intermediate position to dispense a minimum flow rate;

FIG. 6 is a raised section of the adjusting device according to a plane that is orthogonal to the section plane of FIG. 5, in which the adjusting device is in the intermediate position;

FIG. 7 is a raised section of the adjusting device according to a plane passing through a longitudinal axis of the adjusting device, in which the adjusting device is in a totally open position to dispense a nominal flow rate;

FIG. 8 is a raised section of the adjusting device according to a plane that is orthogonal to the section plane of FIG. 7, in which the adjusting device is in the totally open position;

FIG. 9 is a raised section of the adjusting device according to a plane parallel to the section plane of FIG. 7, in which the adjusting device is in the totally open position;

FIG. 10 is an exploded view of first actuating means, second actuating means, a first control member and a second control member;

FIG. 11 is an exploded view of a second embodiment of the adjusting device including shutter means, a mixing chamber and a temperature adjusting device;

FIG. 12 is a perspective view of the first actuating means;

FIG. 13 is a cross section view that shows a grooved coupling between the second control member and the second actuating means.

### DETAILED DESCRIPTION

With reference to the aforementioned figures, numeric reference 1 indicates an adjusting device for water-dispensing units.

The adjusting device 1 can be drivable manually to open, close and adjust the flow rate and temperature of water in the dispensing unit. The water-dispensing unit can be intended to be installed in a shower, in a sink or washbasin etc.

The adjusting device 1 can be installed in a water-dispensing unit of the recessed type. The water-dispensing unit can be, for example, installed at least partially inside a housing cavity obtained in an installation surface (not shown), like for example a wall, a shower panel or a surface of a kitchen sink or of a washbasin. Nevertheless, the adjusting device 1 can also be installed in a water-dispensing unit outside the installation surface, i.e. that protrudes from the installation surface.

The adjusting device 1 for water-dispensing units comprises, in particular, a valve body 2 that extends along a longitudinal axis X (FIG. 2). The valve body 2 is provided with a first inlet 3 for the cold water, with a second inlet 4 for the hot water and with an outlet 5 for the mixed water.

The adjusting device 1 comprises, in particular, shutter means 6 movable along the longitudinal axis X configured to control a flow of water from the first inlet 3 and from the second inlet 4 to the outlet 5.

In the illustrated embodiment, the shutter means 6 comprise a diaphragm element 6B configured to engage and disengage a circumferential seat defined by a transit opening 7E of a mixing chamber 7 as will be disclosed below. In a further possible embodiment that is not illustrated, the shutter means 6 can provide a slide valve, or a disc valve, or a diaphragm valve, or a gate valve or a throttle valve, or another type of hydraulic valve.

The adjusting device 1 comprises, in particular, the mixing chamber 7 that is suitable for receiving and mixing the water coming from the first inlet 3 and from the second inlet 4 so as to supply a flow of outgoing water at a desired temperature.

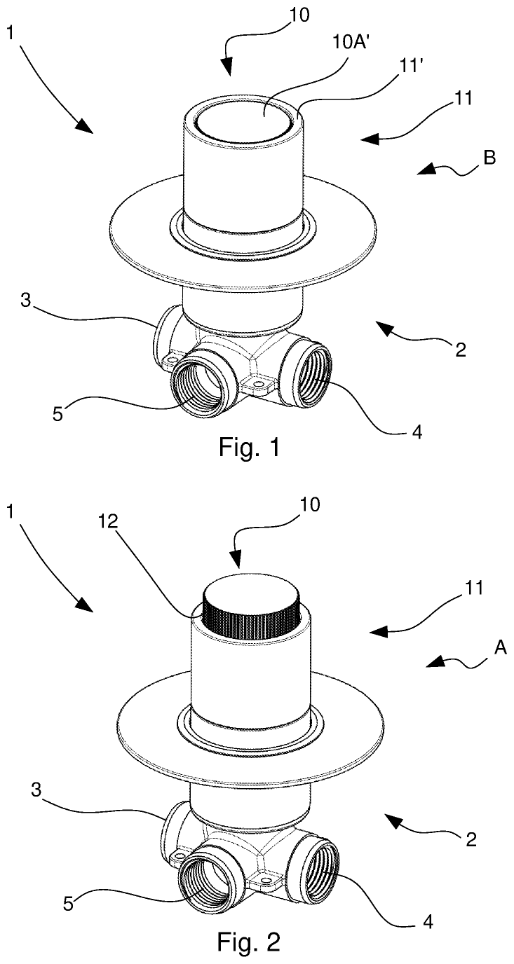

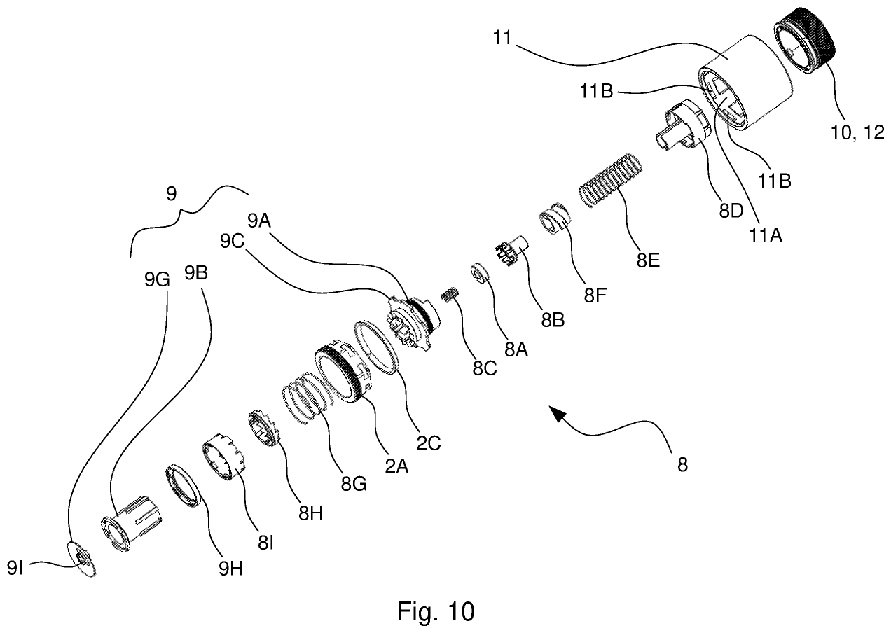

The adjusting device 1 comprises, in particular, first actuating means 8 operationally connected to the shutter means 6 and configured to arrange the shutter means 6 in an open position A, C (FIGS. 2, 5, 6, 7, 8 and 9) and in a closed position B (FIGS. 1, 3 and 4) to respectively enable/disable the transit of the flow of water to the outlet 5.

The first actuating means 8 are further configured to arrange the shutter means 6 in an intermediate adjustable position between a totally open position A (FIGS. 2, 7, 8 and 9) and the closed position B for adjusting a flow of outgoing water. The totally open position A corresponds to a nominal (or maximum) flow rate dispensed to the outlet 5 whereas the closed position B corresponds to a nil water flow rate. In the intermediate position, the shutter means 6 are arranged at an intermediate height—along the longitudinal axis X—with respect to the closed position B and to the totally open position A.

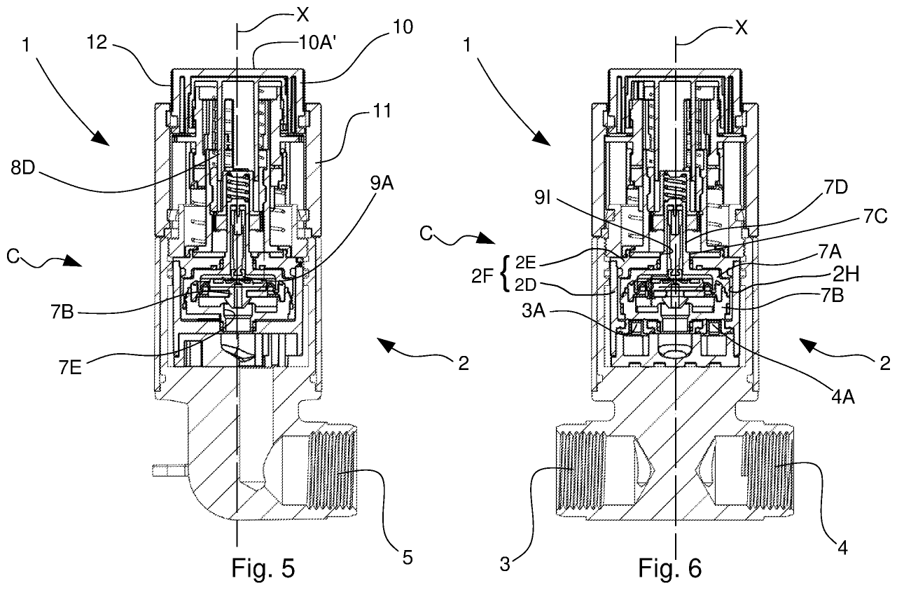

In FIGS. 5 and 6, the intermediate adjustable position can comprise a minimum flow rate position C (FIGS. 5 and 6) in which the shutter means 6 permit dispensing of a minimum flow rate to the outlet 5.

The adjusting device 1 comprises, in particular, second actuating means 9 operationally connected to the mixing chamber 7 and configured to adjust a temperature of the flow of water.

The adjusting device 1 comprises, in particular, a first control member 10 made as a single piece configured to couple with the first actuating means 8 and configured to receive a manual action from a user, or operator, to open, close water dispensing and to adjust the flow rate of the outgoing water.

The first control member 10 is translatable along the longitudinal axis X to open and close water dispensing and is rotatable around the longitudinal axis X to adjust the flow rate of the outgoing water.

The first actuating member 8 comprises, in particular, a magnetic interaction element 8A arranged for interacting with the shutter means 6. The magnetic interaction element 8A is movable along the longitudinal axis X. The magnetic interaction element 8A can have an annular shape to surround at least partially the shutter means 6.

The adjusting device 1 comprises, in particular, a second control member 11 coupling with the second actuating means 9 and configured to receive a manual action from the user to vary the temperature of the flow of water.

The second control member 11 is rotatable around the longitudinal axis X to vary the temperature of the flow of water.

The second actuating means 9 are rotatably integral with the mixing chamber 7. The mixing chamber 7 is rotatable with respect to the valve body 2 around the longitudinal axis X together with the second actuating means 9. The mixing chamber 7 together with the second actuating means 9 rotate around the longitudinal axis X through the effect of a rotation action imposed by the user on the second control member 11. In other words, a rotation of the second control member 11 corresponds to a rotation of the mixing chamber 7 with respect to the valve body 2.

The mixing chamber 7 is provided with the aforesaid transit opening 7E which is arranged for dividing the flow of water coming from the hot water inlet 3 and/or from the cold-water inlet 4 on the basis of a relative position between the mixing chamber 7 and the valve body 2 to set a desired temperature of the flow of outgoing water.

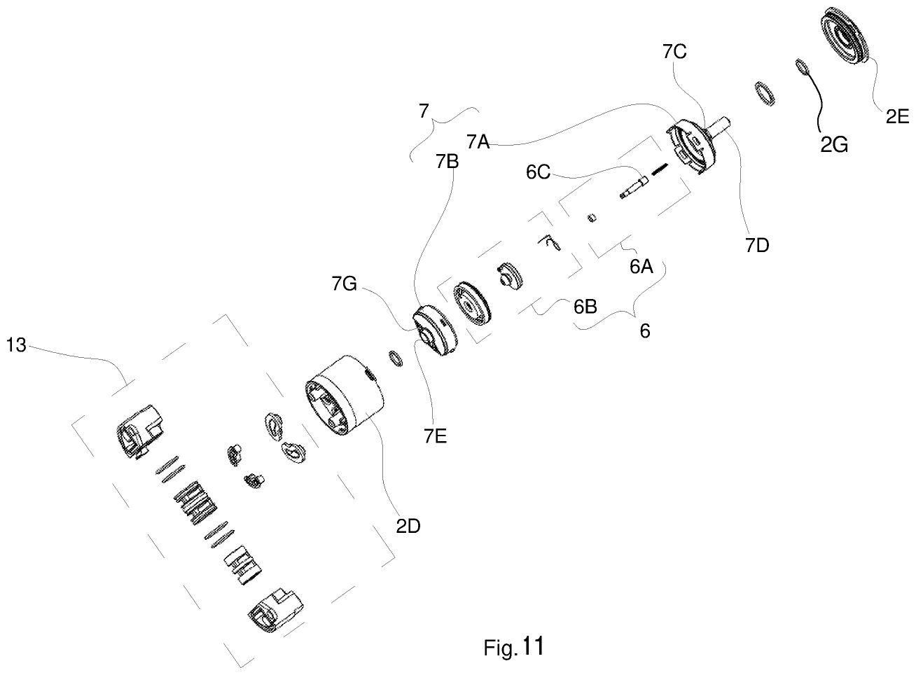

The mixing chamber 7, at a bottom portion thereof, is provided with an inlet hole 7G (FIG. 11) through which cold and/or hot water can flow depending on the position (angular position determined by a rotation around the longitudinal axis X) of the mixing chamber 7 with respect to a first opening 3A for the transit of cold water and to a second opening 4A for the transit of the cold water (FIG. 6). In other words, in the illustrated embodiment, delivering hot and cold water to the mixing chamber 7 is adjusted by a valve of disc type (in particular of double disc type) comprising the inlet hole 7G of the mixing chamber 7 and the first opening 3A and the second opening 4A. The first opening 3A and the second opening 4A are obtained in the valve body 2 and are connected fluidly to the first inlet 3 and to the second inlet 4 respectively.

In the illustrated embodiment, the mixing chamber 7 is bounded by an upper half-mould 7A portion and by a lower half-mould 7B portion that can be fixed removably together (FIG. 11). The upper half-mould 7A portion and the lower half-mould 7A portion are coupled and sealed together. The mixing chamber 7 is provided with a hollow protrusion 7D arranged for containing at least partially, and for guiding along the longitudinal axis X, the shutter means 6. In the illustrated embodiment, the hollow protrusion 7A is provided on the upper half-mould 7A portion. The mixing chamber 7 is provided with a prismatic zone 7C for coupling with the second actuating means 9 to allow integral rotation thereof. In the illustrated embodiment, the prismatic zone 7C is provided in a base portion of the hollow protrusion 7D.

The second control member 11 comprises, in particular, a hollow body that surrounds at least partially the first control member 10 and extends around the longitudinal axis X. The first control member 10 is at least partially inserted-along the longitudinal axis X-into the second control member 11.

The second control member 11 is provided with an outer surface suitable for being grasped by the user to rotate the second control member 11. The second control member 11 comprises, in particular, a sleeve element having an inner tubular surface facing the longitudinal axis X and an outer lateral surface suitable for being grasped by the hand of the user (like a knob) and which is opposite the inner tubular surface. The second control member 11 is thus defined by a knob, having a sleeve shape, intended to be handled by the user to adjust the dispensed water temperature.

The second control member 11 comprises, in particular, an outer upper edge 11′ and an opposite lower edge that faces the valve body 2. The outer upper edge 11′ and/or the lower edge of the second control member can have a substantially circular crown shape.

In the illustrated embodiment, this outer lateral surface is substantially smooth. In a non-illustrated embodiment, such an outer lateral surface can be knurled so as to increase the grip and facilitate grasping and rotation thereof by the user.

The second control member 11 comprises, in particular, a coupling portion 11A configured to connect to the second actuating means 9, and an engaging portion 11B configured to engage a portion of the valve body 2. The engaging portion 11B is housed in a zone of a circumferential seat 21B of the valve body 2 such that the second control member 11 maintains in operation always the same height along the longitudinal axis X, whatever the rotation imparted on the second control member 11. The engaging portion 11B protrudes from the inner tubular surface of the second control member 11 to the longitudinal axis X. In the illustrated embodiment, the engaging portion 11B comprises a plurality of protrusions (FIG. 10). In this illustrated embodiment, the protrusions are arranged at regular intervals on the inner tubular surface of the second control member. In a further embodiment that is not illustrated, the engaging portion can have a substantially annular shape.

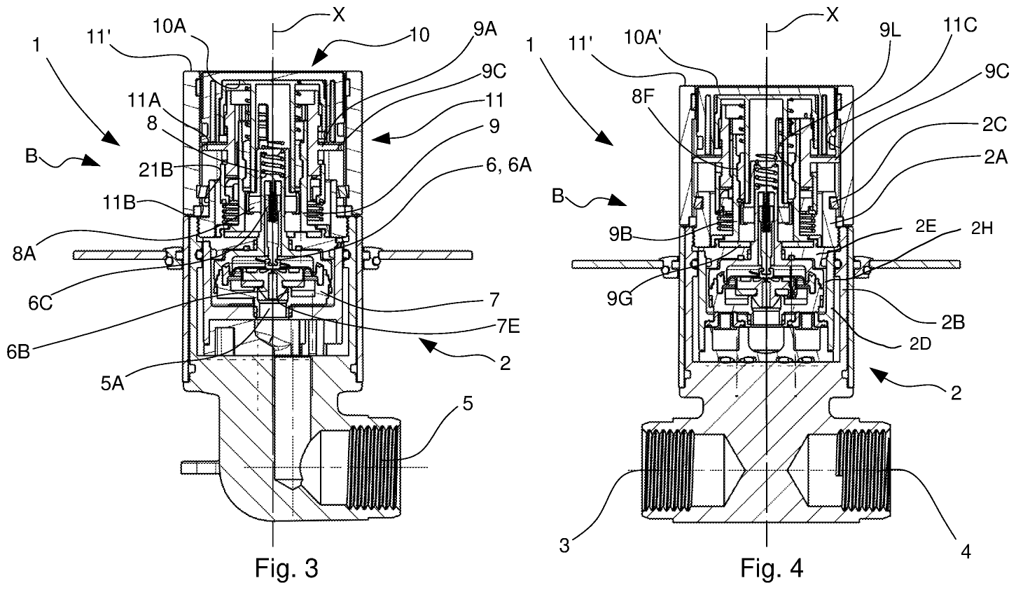

In the illustrated embodiment of the adjusting device 1, the valve body 2 comprises a lower half mould 2B and an upper half mould 2A that are removably fixable to one another (FIG. 4). In this embodiment, the circumferential seat 21 zone is obtained at the upper half mould 2A. The circumferential seat 21B zone is bounded by a ring 2C (elastic ring) fixed to the upper half mould 2A (FIG. 3).

In the illustrated embodiment, the interior of the valve body 2 can comprise a further upper half mould 2E and a further lower half mould 2D (FIG. 11) that are also removably fixable to one another so as to define a housing chamber 2F (FIG. 6) arranged for containing at least partially the mixing chamber 7.

Precisely, the further upper half mould 2E and the further upper half mould 2D are reciprocally coupled and sealed.

In the illustrated embodiment, the further upper half mould 2E is provided with a hole arranged for coupling with the protrusion 7D of the mixing chamber 7 such that this protrusion 7D protrudes from the valve body 2. At the hole, there is a seal ring 2G arranged for preventing the water circulating in the valve body 2 from reaching the first and second actuating means (FIG. 11). Between the housing chamber 2F and the mixing chamber 7, a gap 2H is defined that can be filled with water (FIGS. 4, 6). This gap 2H is in fluid connection with the first inlet 3 and/or with the second inlet 4. In other words, in use, the mixing chamber 7 is immersed in the pressurized fluid (water) in the housing chamber 2F. This particular arrangement enables the operator actuating the second control member 11 (and thus dragging the mixing chamber 7) to perform a “gentle” action, i.e. an action damped by the friction that is generated between the mixing chamber 7 and the water contained in the gap 2H.

The second actuating means 9 comprise, in particular, a movable part 9A arranged for engaging the second control member 11 and a fixed part 9B, 9G that is rotatably fixed to the mixing chamber 7. The movable part 9A and the fixed part 9B, 9G are reciprocally movable longitudinally and rotatably integral with one another. The fixed part 9B, 9G comprises a tubular element 9B and an annular element 9G fixed to the tubular element 9B. The annular element 9G, at a central zone thereof, comprises a coupling hole 91 arranged for engaging the prismatic portion 7C of the mixing chamber 7 (FIG. 10). In one embodiment that is not illustrated, the fixed part of the second actuating means can be made of a single piece. The fixed part 9B, 9G is kept in place by a locking ring 9H fitted to the valve body 2 so that the fixed part 9B, 9G is free to rotate without varying the height thereof along the longitudinal axis X.

The movable part 9A and the fixed part 9B, 9G can be coupled with one another by a grooved coupling. The grooved coupling can be made at an outer surface of the tubular element 9B.

An inner face of the tubular element 9B-facing the longitudinal axis X-is provided with a nut screw coupling surface 9L (FIG. 4) arranged for interacting with the first actuating means 8, as will be explained below.

The movable part 9A of the second actuating means 9 comprise, in particular, a further coupling portion 9C shaped to couple slidingly with the coupling portion 11A of the second control member 11 to permit a reciprocal axial sliding thereof. In other words, between the movable part 9A and the second control member 11 a further grooved coupling is made. In the illustrated embodiment, the further coupling portion 9C comprises a plurality of radial protrusions that extend externally and the coupling portion 11A comprises a plurality of grooves obtained on an inner surface of the hollow body and facing the longitudinal axis X (and facing the actuating means 9).

The shutter means 6 can comprise a movable shutter element 6A arranged for interacting with the diaphragm element 6B to position the diaphragm element 6B at a set height on the longitudinal axis X to set a desired flow rate of the flow of outgoing water. This set height in fact matches a set distance of the diaphragm element 6B from the transit opening 7E; this set distance is matched by a flow rate of outgoing water of the mixing chamber 7 to the outlet 5.

As mentioned, the shutter means 6 can comprise a further magnetic interaction element 6C arranged for interacting with the magnetic interaction element 8A of the first actuating member 8. The further magnetic interaction element 6C is fixed with respect to the movable shutter element 6A and is thus movable together with the latter along the longitudinal axis X.

The first control member 10 comprises, in particular, a coupling surface 10A configured to contact axially the first actuating means 8, and at an action of an operator, to enable or inhibit the transit of said flow of outgoing water.

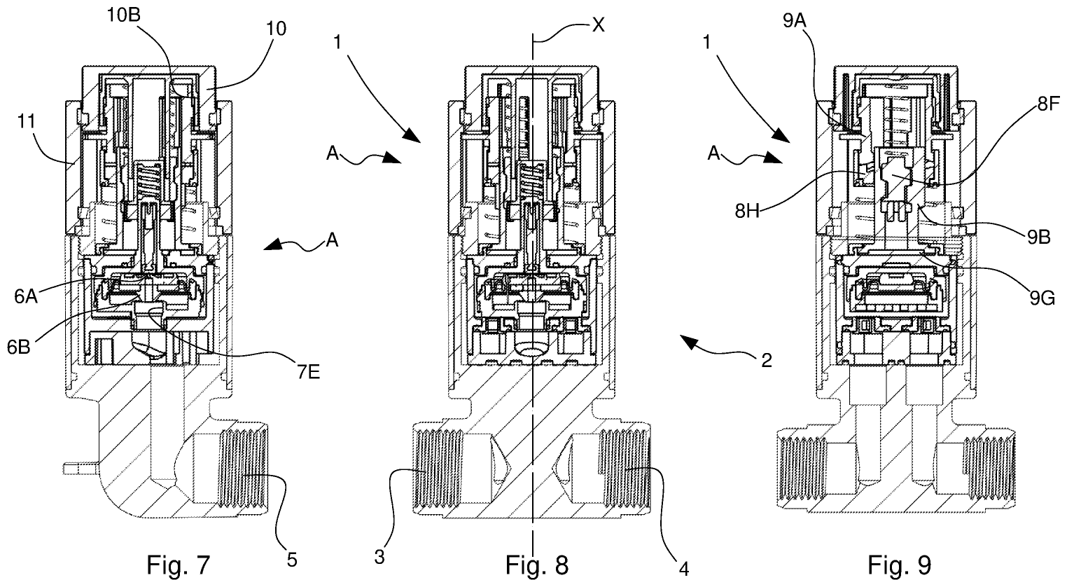

The first control member 10 comprises, in particular, a further engaging portion 10B (FIG. 7) configured to engage slidingly longitudinally the first actuating means 8, and, at an action of an operator, to adjust the flow of outgoing water.

As mentioned, the first control member 10 enables the user to control both enabling/disabling of the outgoing water and adjust the flow rate thereof. In the illustrated embodiment, the first control member 10 is shaped as a hollow cup body having an open part and a closed part, the cavity of which faces the valve body 2.

The coupling surface 10A is obtained on an inner face of the closed part (i.e. positioned in the cavity of the cup body) that faces the first actuating means 8.

On an upper face of the closed part-which is opposite the inner face—an upper surface, or thrust surface 10A′ is obtained, which is arranged for receiving a touch or a thrust action from the operator to act as an actuating pushbutton for the first actuating means 8.

In the closed position B (FIGS. 1, 3 and 4), the first control member 10 is inserted completely inside the second control member 11; more in detail, the upper surface 10A′ of the first control member 10 is flush with the upper edge 11′ of the second control member 11 so that the thrust surface 10A′ and the upper edge 11′ lie on the same reference plane. This reference plane can be transverse, in particular orthogonal, to the longitudinal axis X.

This structural configuration, owing to the flush positioning of the upper surface 10A′ of the first control member 10 with the upper edge 11′ of the second control member 11 in the closed position B moreover enables a pleasing aesthetic effect to be obtained.

In this closed position B, the first control member 10 is inserted completely into, and is completely surrounded by, the second control member 11.

In the open position A, C (FIGS. 2, 5, 6, 7, 8 and 9), the second control member 11 protrudes with respect to the first control member 10 with respect to the transverse reference plane. In this open position A, C, the first control member 10 makes a peripheral control surface 12 (FIGS. 2 and 5) easily accessible to the operator, thus enabling the first control member 10 to be easily rotated to adjust the outgoing flow rate.

As will be disclosed below, the upper surface 10A′ is arranged for interacting with a bistable positioning mechanism. In the illustrated embodiment, the upper surface 10A′ has a substantially flat circular shape. In a further embodiment that is not illustrated, the thrust surface 10A′ can have a shape that is concave towards the valve body 2.

The peripheral actuating surface 12 is on the other hand positioned on an outer surface of the open part of the hollow cup body and is arranged for receiving a rotation action from the user, to act as a further knob for the first actuating means 8. The rotation action on the actuating surface 12 sets a height variation of the shutter means 6 on the longitudinal axis X and thus a variation of the flow rate of water to the outlet 5. In the illustrated embodiment, the peripheral actuating surface 12 can be knurled to facilitate gripping for the user. In one embodiment that is not illustrated, the peripheral actuating surface can be substantially smooth.

The first actuating means 8 comprise, in particular, the bistable positioning mechanism 8D, 8E, 9A, 8G, 8H configured to project along the longitudinal axis X the first control member 10 outside the second control member 11 (in which the first control member 10 is partially inserted) in the open position A, C of the shutter means 6—at a first touch by the operator of the first control member 10—and to insert at least partially, in particular completely, the first control member 10 into the second control member 11 in the closed position B—at a second touch by the operator of the first control member 10. The bistable positioning mechanism can be simile to that provided in click pens.

The bistable positioning mechanism 8D, 8E, 9A, 8G, 8H comprises, in particular, a positioning element 8D provided on an outer peripheral surface thereof of longitudinal grooves arranged for coupling slidingly but integrally in rotation with the further engaging portion 10B. The positioning element 8D is further provided on a side surface thereof with longitudinal ridges arranged for coupling slidingly but integrally in rotation with corresponding grooves of a screw element 8F disclosed below.

The first actuating means 8 comprise, in particular, a screw-screw nut mechanism 8F, 9L configured to convert a rotation caused by an operator on the first control member 10 into a movement along the longitudinal axis of the shutter means 6 so as to vary the flow rate of the outgoing water. In particular, the screw-screw nut mechanism comprises the screw element 8F that is provided externally with a threaded screw surface configured to interact with a corresponding threaded screw nut 9L surface of the tubular element 9B.

The screw element 8F is hollow and is provided on an inner surface with one or more (two in the illustrated embodiment) grooves shaped to couple slidingly and integrally in rotation with the positioning element 8D.

In several passages of the present description grooved mechanical couplings are mentioned in which one component has grooves and another component has ridges; but the position of the grooves and ridges can be reversed on the respective components in function of the specific project needs. Further equivalent embodiments of the couplings are also possible provided that they are suitable for obtaining the same technical effect.

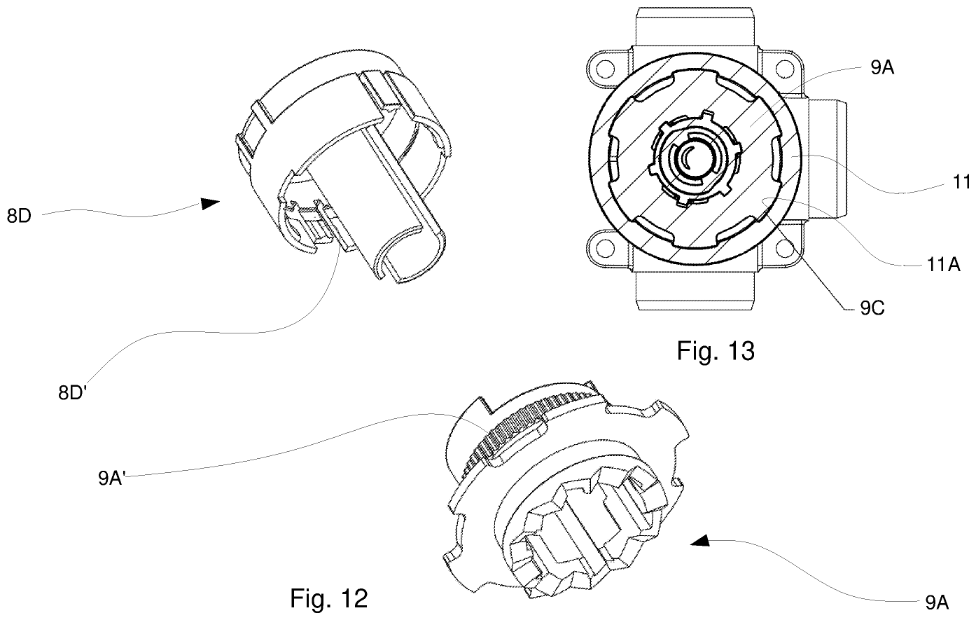

The first actuating means 8 comprise, in particular, a first feedback mechanism that is suitable for providing tactile feedback to the user when the latter rotates the first control member 10. The first feedback mechanism 8D′, 9A′ includes one or more elastic teeth 8D′ (two in the illustrated embodiment) and a toothed crown 9A′ (FIG. 12). The one or more elastic teeth 8D′ can engage the toothed crown 9A′ so as to temporarily maintain an angular position of the first control member 10 without completely preventing the rotation thereof at a rotation action of the user. A predefined flow of water to the outlet 5 corresponds to the angular position. In the illustrated embodiment, the toothed crown 9A′ is positioned circumferentially on the movable part 9A of the second actuating means 9, the two elastic teeth 8D′ are positioned on the positioning element 8D. The positioning element 8D is, with respect to the longitudinal axis X, at least partially inserted into, and surrounded by, the movable part 9A.

In a second embodiment of the adjusting device 1 (FIG. 11) a temperature adjusting device 13 is provided that is configured to compensate for and in particular equal the flow rates of water entering from the first inlet 3 and from the second inlet 4, on the basis of a pressure difference between the first inlet 3 and the second inlet 4. This temperature adjusting device 13 enables undesired mains pressure variations (for example hot water coming from a boiler) to be compensated so as to maintain the outgoing water temperature constant (or by dispensing a lesser flow rate than that envisaged in normal operating conditions, i.e. at a substantially constant network pressure). In a further embodiment that is not illustrated, a different temperature adjusting device, for example of the thermostatic type, can be provided.

The particular configuration of the adjusting device 1 enables a user to easily adjust enabling/disabling, the water flow rate and the water temperature dispensed by just two control members, the first control member 10 and the second control member 11. The adjusting device 1 according to the invention in fact provides a first control member 10 made as a single piece that can both allow/prevent the transit of the water and adjust the flow rate of the water, and a second member 11 that enables the water temperature to be adjusted. This configuration reduces the number of components of the adjusting device, achieving significant advantages both from the structural and ergonomic point of view.

Further, the specific arrangement of the first control member 10 and of the second control member 11, in particular in the closed position B, enables an adjusting device 1 to be obtained that is compact and with relatively modest overall dimensions. Further, in the closed position B, the particular arrangement of the second control member 11 that surrounds the first control member 10 externally enables the user to act directly on the second control member 11 to adjust the temperature even before enabling water dispensing. This arrangement of the first control member 10 with respect to the second control member 11 accordingly implies advantages both from the ergonomic point of view, leaving the user the choice of acting on the two control members in the order that the user prefers and from the energetic point of view, giving the user for example the possibility of setting a relatively low temperature before dispensing the water and thus avoiding wasting energy intended for heating the water.

Further, the capacity of the first control member 10 to protrude outside the second control member 11 enables the peripheral actuating surface 12 to be made available to the user only when necessary, i.e. when the adjusting device 1 is enabled to dispense outgoing water in the open position A, C.

Further, providing a tactile feedback mechanism enables a user to maintain the first control member 10 in a predefined angular position—and thus with a predefined flow rate and at the same time provides the user with a tactile sensation of the rotation action given to the first control member 10.

The magnetic coupling between the magnetic interaction element 8A of the first actuating member 8 and the further magnetic interaction element 6C of the shutter means 6 further enable the user to easily actuate the bistable positioning device by applying a relatively reduced force.

From what has been set out above, it is clear that the adjusting device 1 according to the invention successfully attains the previously mentioned set objects.

What has been disclosed and shown in the appended drawings has been provided by way of illustrative example of the innovative features of the adjusting device 1.

Variations on and/or additions to what has been disclosed and illustrated in the appended drawings are possible.

1. Adjusting device for water-dispensing units, comprising:
a valve body that extends along a longitudinal axis and is provided with a first inlet for the cold water, with a second inlet for the hot water and with an outlet for the mixed water,
shutter means movable along said longitudinal axis configured to control a flow of water from said first and second inlets to said outlet
a mixing chamber suitable for receiving and mixing the water coming from said first inlet and from said second inlet so as to supply an outgoing flow of water at a desired temperature,
first actuating means operationally connected to said shutter means and configured to arrange said shutter means in an open position and in a closed position to respectively enable/disable the transit of said flow of water towards said outlet, said first actuating means being further configured to arrange said shutter means in an intermediate adjustable position between said total open position and said closed position to adjust an outgoing water flow rate,
second actuating means operationally connected to said mixing chamber and configured to adjust a temperature of said flow of water,
a first control member made of a single piece configured to couple with said first actuating means and configured to receive a manual action from a user to open, close dispensing of water and to adjust the flow rate of the outgoing water, wherein said first control member is translatable along said longitudinal axis to open and close dispensing of water and is rotatable around said longitudinal axis to vary the flow rate of the outgoing water,
a second control member coupling with said second actuating means and configured to receive a manual action from said user to vary the temperature of said flow of water, wherein said second control member comprises a hollow body that surrounds at least partially said first control member and extends around said longitudinal axis, wherein said second control member is rotatable around said longitudinal axis to vary the temperature of said flow of water, said second control member being provided with an outer surface intended to be grasped by said user to rotate said second control member.

2. Adjusting device according to claim 1, wherein said second control member is configured as a sleeve body that defines a tubular dial intended to be handled by a user.

3. Adjusting device according to claim 1, wherein said first control member is at least partially inserted—along said longitudinal axis—into said second control member.

4. Adjusting device according to claim 1, wherein said mixing chamber is rotatable with respect to said valve body around said longitudinal axis together with said second actuating means with a rotation action imposed by the user on said second control member.

5. Adjusting device according to claim 1, wherein said second control member comprises a coupling portion configured to connect to said second actuating means, and an engaging portion configured to engage with a portion of said valve body, and wherein the engaging portion is housed in a circumferential seat zone of said valve body such that said second control member always maintains in operation the same position along said longitudinal axis, whatever the rotation imposed on said second control member.

6. Adjusting device according to claim 1, wherein said second actuating means comprise a movable part arranged for engaging with said second control member and a fixed part that is rotatably fixed to said mixing chamber, said movable part and said fixed part being reciprocally movable longitudinally but rotatably integral with one another.

7. Adjusting device according to claim 4, wherein said movable part of said second actuating means comprise a further coupling portion shaped to couple slidingly with said coupling portion of said second control member to permit reciprocal axial movement thereof.

8. Adjusting device according to claim 1, wherein said mixing chamber is provided with at least one transit opening arranged for reducing a flow of water coming from said first inlet and/or from said second inlet on the basis of a relative position between said mixing chamber and said valve body to impose a desired temperature of said flow of outgoing water.

9. Adjusting device according to claim 1, wherein said shutter means comprise a shutter element which is movable and arranged for interacting with a diaphragm element to position said diaphragm element at a set height on said longitudinal axis to impose a desired flow rate on said flow of outgoing water.

10. Adjusting device according to claim 1, wherein said first actuating member comprises a magnetic interaction element and said shutter means comprise a further magnetic interaction element, said first actuating member and said shutter means being connected magnetically.

11. Adjusting device according to claim 1, wherein said first control member comprises a coupling surface configured to contact axially said first actuating means, and by an action of an operator to enable or prevent the transit of said flow of outgoing water, and a further engaging portion configured to engage slidably longitudinally with said first actuating means, and by an action of an operator, to transmit a rotation to said first actuating means so as to adjust said outgoing flow rate.

12. Adjusting device according to claim 1, wherein said first actuating means comprise a screw-nut mechanism configured to convert a rotation caused by an operator on said first control member into a movement along said longitudinal axis of said shutter means so as to vary said outgoing fluid flow rate.

13. Adjusting device according to claim 1, wherein said first actuating means comprise a bistable positioning mechanism configured to project along said longitudinal axis said first control member externally with respect to said second control member in said open position of said shutter means and to insert at least partially, said first control member into said second control member in said closed position.

14. Adjusting device according to claim 11, wherein in said closed position said first control member is inserted completely into said second control member, and wherein an upper surface of said first control member is flush with an upper edge of said second control member, so that said upper surface (10A′) and said upper surface lie on the same plane.

15. Adjusting device according to claim 11, wherein, in said open position, said first control member protrudes outside said second control member, so as to make accessible a peripheral control surface of said first control member to an operator thus permitting the rotation of said first control member to adjust said outgoing flow rate.

16. Adjusting device according to claim 1, comprising a housing chamber inserted into said valve body and shaped to contain at least partially said mixing chamber, between said mixing chamber and said housing chamber a gap being arranged for being filled, in use, with water so that a manual action of the user on said second control member to vary the temperature of the flow of water is damped by the friction between said mixing chamber and the water contained in said gap.
